(19) United States
(12) Patent Application Publication
(10) Pub. No.: US 2026/0012383 A1
(43) Pub. Date: Jan. 8, 2026

(54) SIGNAL CUSTOMIZATION IN VIEW OF LOW RESOLUTION QUANTIZATION

(71) Applicant: Huawei Technologies Co., Ltd., Shenzhen (CN)

(72) Inventors: Nuwan Suresh Ferdinand, Ottawa (CA); Huang Huang, Shenzhen (CN)

(21) Appl. No.: 19/301,125

(22) Filed: Aug. 15, 2025

Related U.S. Application Data
(63) Continuation of application No. PCT/CN2023/077029, filed on Feb. 18, 2023.

(51) Int. Cl. H04L 27/26

(52) U.S. Cl. CPC H04L 27/2618

(57) ABSTRACT

At a device (such as a user equipment), the provision, to a network element (such as a base station), of one or more parameters representative of capabilities of the device may be shown to allow the network element to customize signal generation parameters that are provided to the device. The customized signal generation parameters may be used, by the device, when generating signals destined for the network element or may be used, by the device, when decoding signals received from the network element. The customized signal generation parameters may be selected from among a group of parameters, where the group includes a bandwidth extension ratio, a roll off factor and a guard band factor.

### CROSS-REFERENCE TO RELATED APPLICATION

This application is a continuation of International Application No. PCT/CN2023/077029, entitled “SIGNAL CUSTOMIZATION IN VIEW OF LOW RESOLUTION QUANTIZATION” and filed on Feb. 18, 2023, the disclosure of which is hereby incorporated by reference in its entirety.

### TECHNICAL FIELD

The present disclosure relates, generally, to digital communication and, in particular embodiments, to adaptation to low resolution quantization and, more particularly, customization in view of the low resolution quantization.

### BACKGROUND

Quantization may be considered to be an important step in digital to analog convertors (DAC) or analog to digital convertors (ADC). A main characterization of quantization is a quantization resolution, which may also be referenced as a number of quantization regions. Typically, the quantization regions are represented as bits. For an example, if there are two quantization regions, then a given quantization region may be represented using a single bit. An accuracy of a representation of an analog signal using a quantized signal may be shown to depend on the quantization resolution, that is, the number of quantization regions or bits. A greater quantity of quantization bits may be associated with a so-called “smaller” quantization resolution and a higher number of quantization regions.

A relatively greater quantity of quantization bits may be shown to result in a relatively lower quantization error. The term “quantization error” may be understood to represent a measure of a difference between an unquantized signal and a quantized version of the same signal. Quantization error is often represented as a Euclidean distance between the two signals.

In digital communication, data is often arranged in blocks. A measure of a quality of a digital communication channel is often represented as a block error rate (BLER), which may be expressed as a ratio of a number of blocks erroneously received to a total number of blocks transmitted on the digital communication channel.

The quantity of quantization bits may be shown to impact the BLER performance of a digital communication channel. In general, the higher the quantity of quantization bits, the better the BLER performance. However, complexity may be shown to increase with the quantity of quantization bits. Accordingly, it may be shown to not be feasible to increase the quantity of quantization bits in a manner that increases BLER performance beyond a certain point.

### SUMMARY

At a device (such as a user equipment), the provision, to a network element (such as a base station), of one or more parameters representative of capabilities of the device may be shown to allow the network element to customize signal generation parameters that are provided to the device. The customized signal generation parameters may be used, by the device, when generating signals destined for the network element or may be used, by the device, when decoding signals received from the network element. The customized signal generation parameters may be selected from among a group of parameters, where the group includes a bandwidth extension ratio, a roll off factor and a guard band factor.

Low bit quantization may be considered to be important to DAC applications and to ADC applications. In the downlink direction, it is known that there are receivers that have limited capability and can, accordingly, only perform low bit quantization ADC. Similarly, in the uplink direction, it is known that there are transmitters that have limited capability and can, accordingly, only perform low bit quantization DAC.

Aspects of the present application relate to customizing signal generation parameters to account for the limited capabilities brought about by low bit quantization.

According to an aspect of the present disclosure, there is provided a method for carrying out at a device. The method includes transmitting, to a network element, an indication of a signal parameter, the signal parameter selected based on capabilities of the device, receiving, from the network element, a signal generation parameter, the signal generation parameter selected, at the network element, based, at least in part, on the signal parameter and transmitting a signal, the signal generated according to the signal generation parameter.

According to an aspect of the present disclosure, there is provided a method for carrying out at a network element. The method includes receiving, from a device, an indication of a signal parameter, the signal parameter selected, by the device, based on capabilities of the device, transmitting, to the device, a signal generation parameter, the signal generation parameter selected based, at least in part, on the signal parameter, receiving a signal and decoding, according to the signal generation parameter, the signal.

According to an aspect of the present disclosure, there is provided a method for carrying out at a device. The method includes transmitting, to a network element, an indication of a signal parameter, the signal parameter selected based on capabilities of the device, receiving, from the network element, a signal generation parameter, the signal generation parameter selected based, at least in part, on the signal parameter, receiving a signal and decoding, according to the signal generation parameter, the signal.

According to an aspect of the present disclosure, there is provided a method for carrying out at a network element. The method includes receiving, from a device, an indication of a signal parameter, the signal parameter selected, by the device, based on capabilities of the device, transmitting, to the device, a signal generation parameter, the signal generation parameter selected based, at least in part, on the signal parameter and transmitting a signal, the signal generated according to the signal generation parameter.

According to an aspect of the disclosure, there is provided a device including a processor and a computer-readable storage media. The computer-readable storage media has stored thereon, computer executable instructions, that when executed by the processor, perform a method as described above or detailed below.

According to an aspect of the disclosure, there is provided a non-transitory computer readable storage medium, wherein the computer readable storage medium stores instructions that, when executed by a processor of an apparatus, enable the apparatus to perform a method as described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates, in a block diagram, an example transmitter for a Single Carrier Offset Quadrature Amplitude Modulation (SC-OQAM) signal;

FIG. 7 illustrates, in a block diagram, an example transmitter for an Direct Fourier Transform spread Orthogonal Frequency Division Multiplexing signal;

FIG. 8 illustrates, in the frequency domain, pulse shaping and guard band allocation;

FIG. 9 illustrates a signal parameter selector by which signal parameters may be selected, in accordance with aspects of the present application;

FIG. 10 illustrates a signal flow diagram for configuring an uplink transmission, in accordance with aspects of the present application;

FIG. 11A illustrates a first table relating two-bit combinations to a first plurality of specific roll off factors, in accordance with aspects of the present application;

FIG. 11B illustrates a second table relating two-bit combinations to a second plurality of specific roll off factors, in accordance with aspects of the present application; and

FIG. 12 illustrates a signal flow diagram for configuring a downlink transmission, in accordance with aspects of the present application.

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

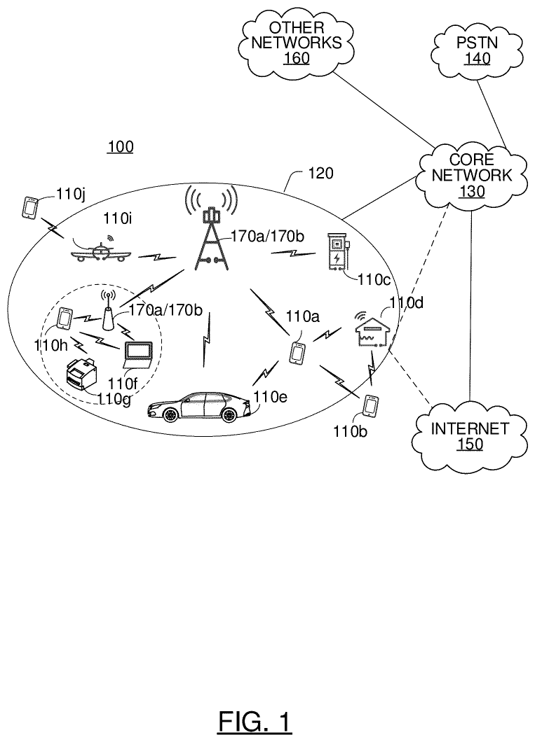

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

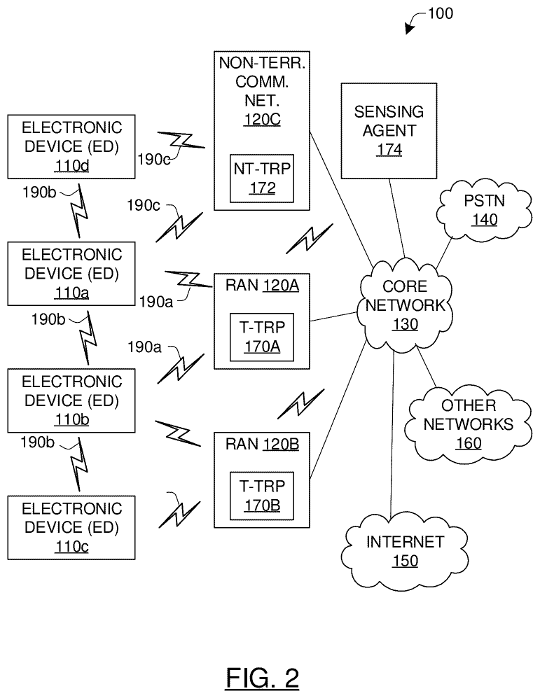

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

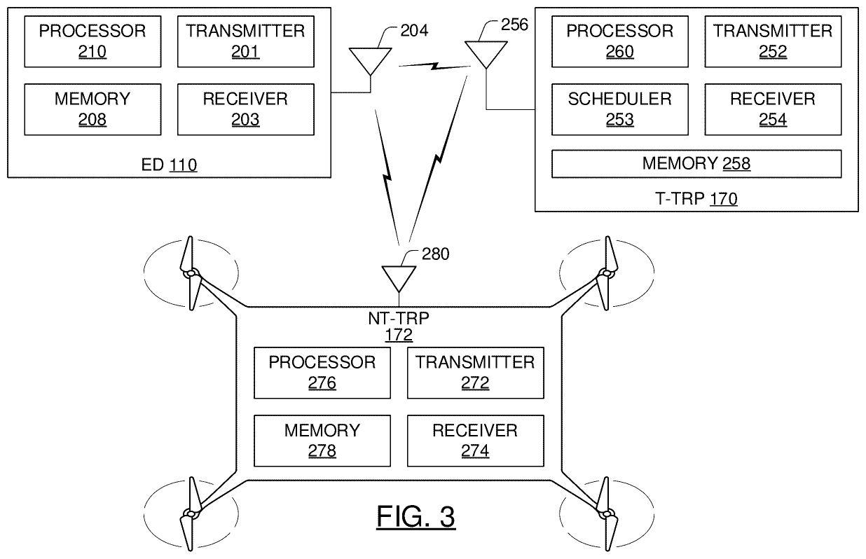

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

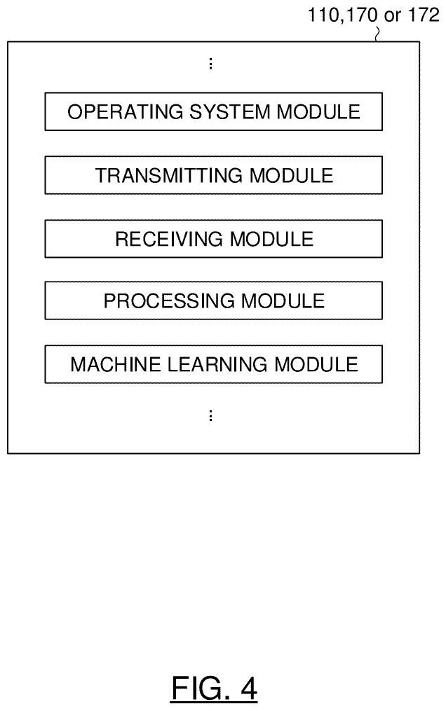

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-s-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

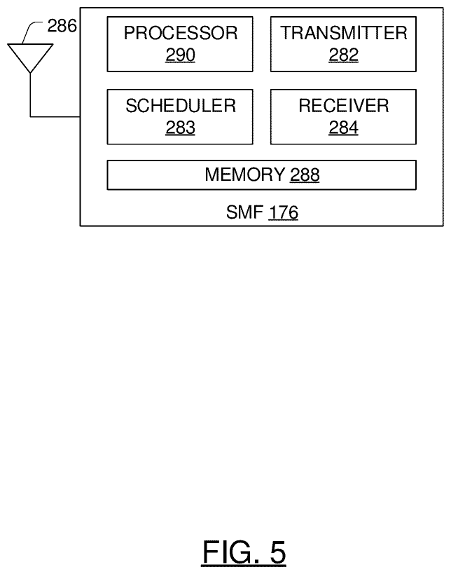

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

Notably, there are applications where low bit quantization may be considered to be important. Indeed, low bit quantization may be considered to be important to DAC applications and to ADC applications. In the downlink direction, it is known that there are receivers, in UEs 110, that have limited capability and can, accordingly, only perform low bit quantization ADC. Similarly, in the uplink direction, it is known that there are transmitters, in UEs 110, that have limited capability and can, accordingly, only perform low bit quantization DAC.

Aspects of the present application relate to using frequency-domain spectral shaping (FDSS) and guard bands with tone reservation (TR) to improve BLER performance when low bit quantization is to be used at DAC/ADC components. FDSS may be referred to, generally, as “pulse shaping.” The use of FDSS may be shown to help to limit a Peak-to-Average Power Ratio (PAPR) of a given waveform. The use of FDSS may also be shown to help to limit signal variation around an average power. It is known that a guard band may be used as a protection for in-band emission. Further, a tone may be used in the guard band as a tone reservation (TR). The use of such tones may be shown to minimize the PAPR or the signal variation around the average power. Alternatively, the tones may be used to separately reduce the PAPR of a real component (I) and an imaginary component (Q).

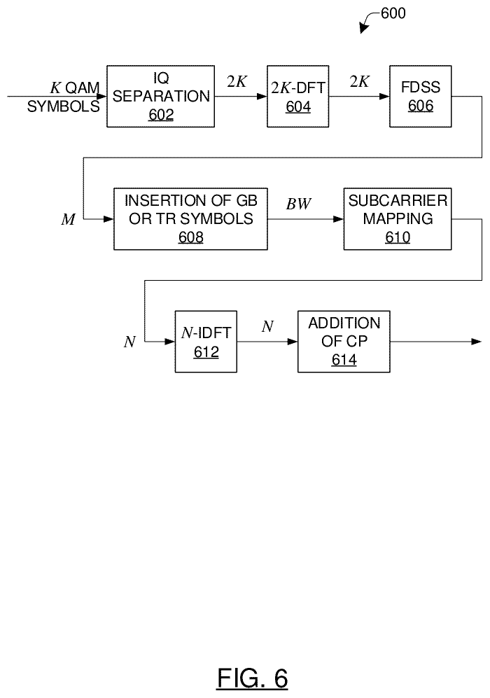

FIG. 6 illustrates, in a block diagram, an example transmitter 600 for a Single Carrier Offset Quadrature Amplitude Modulation (SC-OQAM) signal. Initially, K QAM symbols are received by a IQ separation block 602. Output from the IQ separation block 602 is received by a DFT block 604. Output from the DFT block 604 is received by an FDSS block 606. Output from the FDSS block 606 is received by a block 608 at which a guard band (GB) may be inserted or TR symbols may be inserted. Output from the GB or TR insertion block 608 is received by a subcarrier mapping block 610. Output from the subcarrier mapping block 610 is received by an N-IDFT block 612. Output from the N-IDFT block 612 is received by a block 614 at which a cyclic prefix (CP) is added to result in the desired SC-OQAM signal.

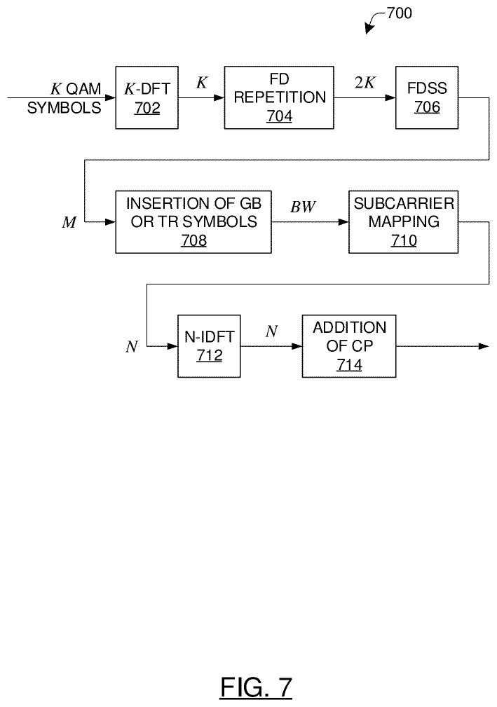

FIG. 7 illustrates, in a block diagram, an example transmitter 700 for a DFT-s-OFDM signal. Initially, K QAM symbols are received by a K-DFT block 702. Output from the K-DFT block 702 is received by a frequency domain (FD) repetition block 704. Output from the FD repetition block 704 is received by an FDSS block 706. Output from the FDSS block 706 is received by a block 708 at which a GB may be inserted or TR symbols may be inserted. Output from the GB or TR insertion block 708 is received by a subcarrier mapping block 710. Output from the subcarrier mapping block 710 is received by an N-IDFT block 712. Output from the N-IDFT block 712 is received by a block 714 at which a cyclic prefix (CP) is added to result in the desired DFT-s-OFDM signal.

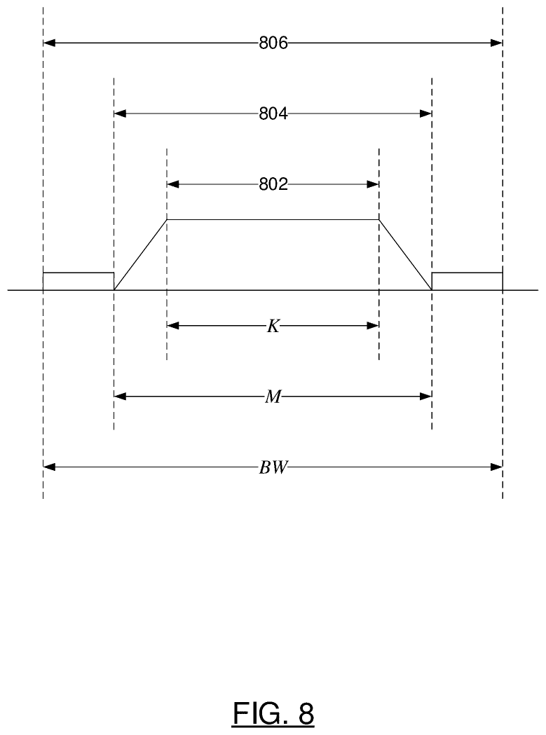

FIG. 8 illustrates, in the frequency domain, pulse shaping and GB allocation. It is known that a given UE 110 may be allocated with a bandwidth. Indeed, the allocated bandwidth may be expressed as a number, BW, of subcarriers. Within the allocated BW subcarriers, the given UE 110 may use K subcarriers to transmit K symbols. The given UE 110 may, in part, use pulse shaping to extend the K subcarriers to M subcarriers. In the SC-OQAM transmitter 600, a combination of the IQ separation block 602, the DFT block 604 and the FDSS block 606 may be shown to extend K symbols to M subcarriers. In the DFT-s-OFDM transmitter 700, a combination of the K-IDFT block 702, the FD repetition block 704 and the FDSS block 606 may be shown to extend K symbols to M subcarriers.

In a case wherein M subcarriers, among the BW allocated subcarriers, are used for carrying the K symbols, it may be shown the remaining BW-M subcarriers may be used for guard bands. As mentioned hereinbefore, the guard band may be used for tone reservation.

FIG. 8 illustrates a frequency domain representation of a signal. As discussed hereinbefore, it may be considered that a given signal may be represented by K symbols. In the frequency domain representation of FIG. 8, the K subcarriers designated for carrying the K symbols may be understood to be contained within a frequency range associated with reference numeral 802. Through the implementation of pulse shaping, discussed hereinbefore, the K symbols may be carried by M subcarriers. In the frequency domain representation of FIG. 8, the M subcarriers designated for carrying the K symbols, after pulse shaping, may be understood to be contained within a frequency range associated with reference numeral 804. Recall that the given UE 110 may be allocated BW subcarriers. In the frequency domain representation of FIG. 8, the BW allocated subcarriers may be understood to be contained within a frequency range associated with reference numeral 806. In the frequency domain representation of FIG. 8, half of the BW-M subcarriers are illustrated as being used for guard bands on either end of the frequency domain representation of the pulse shaped signal.

The implementation of the pulse shaping that allows the K symbols to be carried by M subcarriers may be described as having a “roll off factor.” The roll off factor may be represented by the Greek letter, α. The roll off factor, α, may be defined in terms of M and K, as

$$α = \frac{M}{K} - 1.$$

More generally, the roll off factor, α, may be defined as a function, ƒ, of a ratio of M to K, that is,

$$α = f ( \frac{M}{K} ) .$$

It may be shown that there is a predictable relationship between roll off factor and signal variation at the output of a transmitter. Indeed, it may be shown that increases in roll off factor are associated with decreases in signal variation.

It may be shown that, in the context of low bit quantization, decreases in signal variation lead to improvements in BLER performance. That is, increases in roll off factor are, conveniently, associated with reduced error rates.

It is known that guard bands may be used for tone reservation. It may be shown that use of tone reservation may lead to reduced signal variance. It is also known that guard bands may be used to reduce the variance of real components and the variance of imaginary components. It is also known that guard bands may be used to reduce so-called “in-band emission.”

The implementation of the guard bands may be defined by a guard band factor, β. The guard band (GB) factor, β, may be shown to vary as a function, g, of a ratio of M to BW, that is,

$$β = g ( \frac{M}{BW} ) .$$

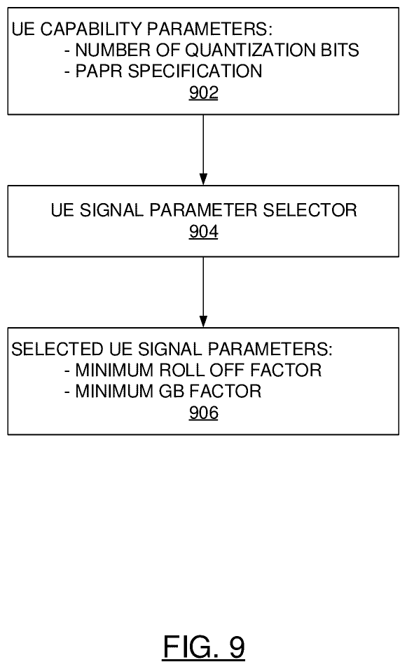

It is known for the BW to be allocated, to a UE 110, by a BS 170. Based on capability parameters associated with the UE 110, the UE 110 may select UE signal parameters, which may be shared with the BS 170. FIG. 9 illustrates a mechanism by which the UE 110 may select UE signal parameters. In particular, FIG. 9 illustrates a UE signal parameter selector 904. The UE signal parameter selector 904 receives, as input, UE capability parameters 902 associated with the UE 110. The UE capability parameters 902 may, for example, include an indication of a number of quantization bits and a specification of a desired PAPR. The UE capability parameters 902 associated with the UE 110 may be shown to differ for different BWs, modulation-coding schemes (MCSs) or modulation orders. The output of the UE signal parameter selector 904 is at least one UE signal parameter. More likely, the output of the UE signal parameter selector 904 is a plurality of UE signal parameters. The UE signal parameters may, for example, include a minimum roll off factor,

$${α}_{min} = f ( \frac{M}{K} ) ,$$

and a minimum GB factor,

$${β}_{min} = g ( \frac{M}{BW} ) .$$

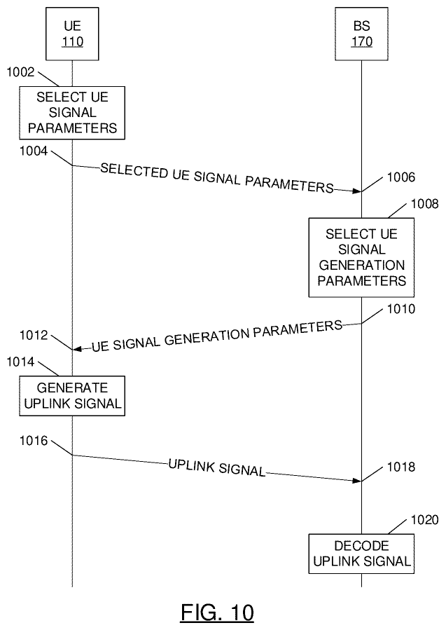

FIG. 10 illustrates a signal flow diagram for configuring an uplink transmission. Once the UE 110 has, for example, using the UE signal parameter selector 904, selected (step 1002) a set of UE signal parameters, the UE 110 may transmit (step 1004) the UE signal parameters to the BS 170. As discussed hereinbefore, the UE signal parameters may include a minimum roll off factor,

$${α}_{min} = f ( \frac{M}{K} ) ,$$

and a minimum GB factor,

$${β}_{min} = g ( \frac{M}{BW} ) .$$

More particularly, the UE signal parameters may include more than one minimum roll off factor, αₘᵢₙ, and more than one minimum GB factor, βₘᵢₙ. Indeed, in one example, the UE 110 may indicate, to the BS 170, two minimum roll off factors, with each of the two minimum roll off factors being associated with a particular range of BW. In another example, the UE 110 may indicate, to the BS 170, two minimum roll off factors, with each of the two minimum roll off factors being associated with a particular range of MCS index. In a further example, the UE 110 may indicate, to the BS 170, two minimum roll off factors, with each of the two minimum roll off factors being associated with a particular range of modulation order. It should be clear that more than two minimum roll off factors may be communicated for more than two ranges of a particular parameter or for combinations of ranges of parameters. Although the foregoing specifically references minimum roll off factors, it should be clear that the indication, by the UE 110 to the BS 170, of the UE signal parameters may include, additionally or alternatively, more than one minimum GB factor.

Upon receiving (step 1006) the UE signal parameters, the BS 170 may select (step 1008) UE signal generation parameters for allocation to the UE 110. The BS 170 may base the selecting (step 1008) of the UE signal generation parameters on the αₘᵢₙ and/or the βₘᵢₙ, received, in step 1006, among the UE signal parameters.

For a first example, consider that the BS 170 has received (step 1006), from the UE 110, a first minimum roll off factor,

$${α}_{min}^{1} ,$$

to be associated with those BW that are greater than or equal to an example threshold of 100 wireless resource blocks and a second minimum roll off factor,

$${α}_{min}^{2} ,$$

to be associated with those BW that are less than the example threshold of 100 wireless resource blocks. Notably, it may be expected that

$${α}_{min}^{1} > {α}_{min}^{2} .$$

It may be shown that as BW increases, a parameter called “oversampling ratio” decreases. A decrease in oversampling ratio is known to be associated with a decrease in an effective number of quantization bits. Accordingly, it may be considered that, for larger BW values, a lower PAPR waveform may be desired. Additionally, for larger BW values, larger minimum roll off factors may be desired. Similarly, for larger BW values, larger minimum GB factors may be desired.

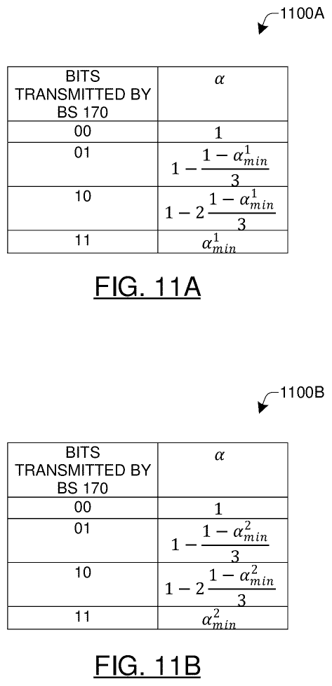

FIG. 11A illustrates a first table 1100A relating two-bit combinations to a first plurality of specific roll off factors, from which the BS 170 may select (step 1008). The first plurality of specific roll off factors are based on the first minimum roll on factor,

$${α}_{min}^{1} .$$

FIG. 11B illustrates a second table 1100B relating two-bit combinations to a second plurality of specific roll off factors, from which the BS 170 may select (step 1008). The second plurality of specific roll off factors are based on the second minimum roll off factor,

$${α}_{min}^{2} .$$

When selecting (step 1008) the UE signal generation parameters, the BS 170 may first select a desired BW. Subsequently, and based on the value of the selected BW relative to the example threshold of 100 wireless resource blocks, the BS 170 may select the first table 1100A (FIG. 11A) or the second table 1100B (FIG. 11B). Upon selecting an appropriate table, the BS 170 may then select a roll off factor, α, from among the four (in this two-bit case) available roll off factors in the selected table.

For a second example, consider that the BS 170 has received (step 1006), from the UE 110, a first minimum roll off factor,

$${α}_{min}^{1} ,$$

to be associated with those MICS indices that are greater than or equal to an example threshold of 10 and a second minimum roll off factor

$${α}_{min}^{2} ,$$

to be associated with those MCS indices that are less than the example threshold of 10. Notably, it may be expected that

$${α}_{min}^{1} > {α}_{min}^{2} .$$

It may be shown that, for higher MCS indices, a lower PAPR waveform may be desired. Additionally, for larger MCS indices, larger minimum roll off factors may be desired. Similarly, for larger MCS indices, larger minimum GB factors may be desired.

When selecting (step 1008) the UE signal generation parameters, the BS 170 may first select a desired MCS index. Subsequently, and based on the value of the selected MCS index relative to the example threshold of 10, the BS 170 may select the first table 1100A (FIG. 11A) or the second table 1100B (FIG. 11B). Upon selecting an appropriate table, the BS 170 may then select a roll off factor, a, from among the four (in this two-bit case) available roll off factors in the selected table.

For a third example, consider that the BS 170 has received (step 1006), from the UE 110, a first minimum roll off factor,

$${α}_{min}^{1} ,$$

to be associated with those modulation orders that are greater than or equal to an example threshold of 16QAM and a second minimum roll off factor,

$${α}_{min}^{2} ,$$

to be associated with those modulation orders that are less than the example threshold of 16QAM. Notably, it may be expected that

$${α}_{min}^{1} > {α}_{min}^{2} .$$

It may be shown that, for higher modulation orders, a lower PAPR waveform may be desired. Additionally, for larger modulation orders, larger minimum roll off factors may be desired. Similarly, for larger modulation orders, larger minimum GB factors may be desired.

When selecting (step 1008) the UE signal generation parameters, the BS 170 may first select a desired modulation order. Subsequently, and based on the value of the selected modulation order relative to the example threshold of 16QAM, the BS 170 may select the first table 1100A (FIG. 11A) or the second table 1100B (FIG. 11B). Upon selecting an appropriate table, the BS 170 may then select a roll off factor, a, from among the four (in this two-bit case) available roll off factors in the selected table.

Upon completion of the selecting (step 1008) of the UE signal generation parameters, the BS 170 may transmit (step 1010), to the UE 110, indications of the UE signal generation parameters. The indications of the UE signal generation parameters may include an indication of an MCS index, an indication of a selected roll off factor, α, an indication of a selected GB factor, β, and an indication of a BW. The indication of the selected roll off factor, α, may be expressed as a two-bit indication, as discussed in relation to the tables 1100A (FIG. 11A) and 1100B (FIG. 11B). The indication of the selected GB factor, β, may be expressed using a two-bit indication, in a manner consistent with the manner in which the selected roll off factor, α, may be expressed. Upon receiving (step 1012) the indications of the UE signal generation parameters, the UE 110 may generate (step 1014) an uplink signal using the received UE signal generation parameters. The UE 110 may then transmit (step 1016), to the BS 170, the uplink signal. Upon receiving (step 1018) the uplink signal, the BS 170 may decode (step 1020) the uplink signal based, at least in part, on the UE signal generation parameters transmitted, to the UE 110, in step 1010.

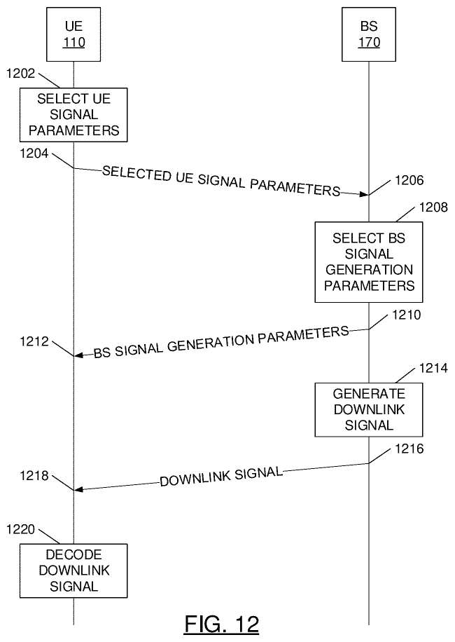

FIG. 12 illustrates a signal flow diagram for configuring a downlink transmission. Once the UE 110 has, for example, using the UE signal parameter selector 904, selected (step 1202) a set of UE signal parameters, the UE 110 may transmit (step 1204) the UE signal parameters to the BS 170. Upon receiving (step 1206) the UE signal parameters, the BS 170 may select (step 1208) a set of BS signal generation parameters. The BS 170 may then transmit (step 1210), to the UE 110, an indication of the selected set of BS signal generation parameters.

In a manner consistent with the indications of the UE signal generation parameters transmitted in step 1010 (FIG. 10), the indications of the BS signal generation parameters may include an indication of an MCS index, an indication of a selected roll off factor, α, an indication of a selected GB factor, β, and an indication of a BW.

Subsequent to transmitting (step 1210), to the UE 110, the indication of the selected set of BS signal generation parameters, the BS 170 may generate (step 1214) a downlink signal according to the selected set of BS signal generation parameters. The BS 170 may then transmit (step 1216), to the UE 110, the downlink signal. Upon receiving (step 1218) the downlink signal, the UE 110 may decode (step 1220) the downlink signal in accordance with the BS signal generation parameters received in step 1212.

In step 1002 of FIG. 10 and step 1202 of FIG. 12, the UE 110 selects a set of UE signal parameters. The UE signal parameters discussed, to this point, have included one or more minimum roll off factors, a, and/or one or more minimum GB factors, B.

According to aspects of the present application, an alternative UE signal parameter may be selected in step 1002 of FIG. 10 and step 1202 of FIG. 12. The alternative UE signal parameter may be referenced as a “BW extension ratio, BWE.” The BW extension ratio, BWE, may be defined as a function of BW and K,

$$BWE = \frac{BW}{K} - 1 .$$

According to aspects of the present application, the UE 110 need not indicate, to the BS 170, a precise value of a BW extension ratio, BWE, possible given the capabilities of the UE 110. Instead, the UE 110 may transmit (step 1004 of FIG. 10, step 1204 of FIG. 12) to the BS 170, an indication of whether a BW extension ratio, BWE, to be selected by the BS 170 may exceed a threshold, γ. This indication may be accomplished using a single bit. One value of the single bit may be called a threshold exceeding prevention indication and the other value of the bit may be called a threshold exceeding allowance indication.

According to aspects of the present application, the capability of the UE 110 to handle a selected BW extension ratio, BWE, that exceeds the threshold, γ, or does not exceed the threshold, γ, may be used to establish whether or not one or more of pulse shaping (FDSS) and TR are to be used for signal transmission.

For one example, if the UE 110 selects (in step 1002, FIG. 10, or in step 1202, FIG. 12) to indicate a capability to handle only those BW extension ratios, BWEs, that do not exceed the threshold, γ, either FDSS or TR may be used when the UE 110 transmits (step 1016) the uplink signal or when the BS 170 transmits (step 1216) the downlink signal. The UE 110 may further select which of either FDSS or TR is preferred. The UE 110 may use a single bit to indicate which of either FDSS or TR is preferred.

For another example, if the UE 110 selects (in step 1002, FIG. 10, or in step 1202, FIG. 12) to indicate a capability to handle BW extension ratios, BWE, that exceed the threshold, γ, both FDSS and TR may be used when the UE 110 transmits (step 1016) the uplink signal or when the BS 170 transmits (step 1216) the downlink signal.

For those situations wherein both FDSS and TR are to be used, it may be shown to be helpful to establish an agreed-upon FDSS-to-TR ratio for use when transmitting a signal (uplink or downlink). Indeed, a plurality of agreed-upon FDSS-to-TR ratios may be defined for the UE 110. In a scenario wherein two agreed-upon FDSS-to-TR ratios have been defined, the UE 110 may use a single bit to indicate, to the BS 170, which of the two agreed-upon FDSS-to-TR ratios is preferred. It may be shown that a higher FDSS is preferred. A split may be defined that establishes 75% FDSS and 25% TR. This split may be referenced as an FDSS-to-TR ratio of 0.75. An alternate split may be defined that establishes 90% FDSS and 10% TR. This split may be referenced as an FDSS-to-TR ratio of 0.9.

Once the UE 110 has selected (step 1002) a UE signal parameter, the UE 110 may transmit (step 1004) the UE signal parameter to the BS 170. As discussed hereinbefore, the UE signal parameter may be a two-bit value with the first bit indicating whether a BW extension ratio, BWE, to be selected by the BS 170 may exceed the threshold, γ, and with the second bit indicating which of two agreed-upon FDSS-to-TR ratios is preferred.

Upon receiving (step 1006) the UE signal parameter, the BS 170 may select (step 1008) UE signal generation parameters for allocation to the UE 110. The BS 170 may base the selecting (step 1008) of the UE signal generation parameters on the one-bit indication regarding whether a BW extension ratio, BWE, to be selected by the BS 170 may exceed the threshold, γ. If the BW extension ratio is allowed to exceed the threshold, γ, the BS 170 may further base the selecting (step 1008) of the UE signal generation parameters on the one-bit indication of which of two agreed-upon FDSS-to-TR ratios is preferred. If the BW extension ratio is allowed to exceed the threshold, γ, the BS 170 may further base the selecting (step 1008) of the UE signal generation parameters on the one-bit indication of which of either FDSS or TR is preferred.

When selecting (step 1008) the UE signal generation parameters, the BS 170 may select an MCS index, a BW extension ratio and a BW. Upon completion of the selecting (step 1008) of the UE signal generation parameters, the BS 170 may transmit (step 1010), to the UE 110, indications of the UE signal generation parameters. The indications of the UE signal generation parameters may include an indication of the selected MCS index, an indication of the selected BW extension ratio and an indication of the selected BW.

For those cases wherein the UE 110 is to use both pulse shaping and guard band, the transmission (step 1010), by the BS 170, of indications of UE signal generation parameters, the indications may include parameters related to a ratio between a pulse shaping and a guard band. Such parameters may include the parameters {BW, K, M} (see FIG. 8) or combination of these parameters, such as

$$\{ BW , α = \frac{M}{K} - 1 , \{ K or M \} \} or \{ BW , α , \{ K or \frac{BW}{M} \} \} .$$

Upon receiving (step 1012) the indications of the UE signal generation parameters, the UE 110 may generate (step 1014) an uplink signal using the received UE signal generation parameters. The UE 110 may then transmit (step 1016), to the BS 170, the uplink signal. Upon receiving (step 1018) the uplink signal, the BS 170 may decode (step 1020) the uplink signal based, at least in part, on the UE signal generation parameters transmitted, to the UE 110, in step 1010.

Once the UE 110 has selected (step 1202) a UE signal parameter, the UE 110 may transmit (step 1204) the UE signal parameter to the BS 170. As discussed hereinbefore, the UE signal parameter may be a two-bit value with the first bit indicating whether a BW extension ratio, BWE, to be selected by the BS 170 may exceed the threshold, γ, and with the second bit indicating which of two agreed-upon FDSS-to-TR ratios is preferred.

Upon receiving (step 1206) the UE signal parameter, the BS 170 may select (step 1208) a set of BS signal generation parameters. When selecting (step 1208) the BS signal generation parameters, the BS 170 may select an MCS index, a BW extension ratio and a BW. Upon completion of the selecting (step 1208) of the UE signal generation parameters, and in a manner consistent with the indications of the UE signal generation parameters transmitted in step 1010 (FIG. 10), the BS 170 may transmit (step 1210), to the UE 110, indications of the BS signal generation parameters. The indications of the BS signal generation parameters may include an indication of the selected MCS index, an indication of the selected BW extension ratio and an indication of the selected BW.

For those cases wherein the BS 170 is to use both pulse shaping and guard band, the transmission (step 1210), by the BS 170, of indications of BS signal generation parameters, the indications may include parameters related to a ratio between a pulse shaping and a guard band. Such parameters may include the parameters {BW, K, M} (see FIG. 8) or combination of these parameters.

Subsequent to transmitting (step 1210), to the UE 110, the indication of the selected set of BS signal generation parameters, the BS 170 may generate (step 1214) a downlink signal according to the selected set of BS signal generation parameters. The BS 170 may then transmit (step 1216), to the UE 110, the downlink signal. Upon receiving (step 1218) the downlink signal, the UE 110 may decode (step 1220) the downlink signal in accordance with the BS signal generation parameters received in step 1212.

In aspects of the present application, the signal parameters transmitted (step 1004, FIG. 10), by the UE 110, may include the threshold, γ, a parameter related to applying FDSS and an indication that the bandwidth extension ratio is smaller or no larger than the threshold, γ.

In aspects of the present application, the signal parameters transmitted (step 1004, FIG. 10), by the UE 110, may include the threshold, γ, a parameter related to applying tone reservation and an indication that the bandwidth extension ratio is smaller or no larger than the threshold, γ.

In aspects of the present application, the signal parameters transmitted (step 1004, FIG. 10), by the UE 110, may include the threshold, γ, a parameter related to applying FDSS and tone reservation and an indication that the bandwidth extension ratio is larger or no smaller than the threshold, γ.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method, for carrying out at a device, the method comprising:
transmitting, to a network element, a plurality of indications of signal parameters, the signal parameters selected based on capabilities of the device, the signal parameters including at least one of a minimum roll off factor and a minimum guard factor;
receiving, from the network element, a plurality of indications of signal generation parameters; and
transmitting a signal, the signal generated according to the signal generation parameters.

2. The method of claim 1, wherein the plurality of indications of the signal parameters are associated with at least one of a range of modulation-coding scheme indices, a range of bandwidths, or a range of modulation orders.

3. The method of claim 1, wherein the plurality of indications of the signal parameters comprises a threshold and further comprises an indication that the signal generation parameters are expected to include a parameter related to applying frequency-domain spectral shaping, and an indication that the bandwidth extension ratio is smaller or no larger than the threshold.

4. The method of claim 1, wherein the plurality of indications of the signal parameters comprises a threshold and further comprises an indication that the signal generation parameters include a parameter related to providing tone reservation, and an indication that the bandwidth extension ratio is smaller or no larger than the threshold.

5. The method of claim 1, wherein the plurality of indications of the signal parameters comprises a threshold and further comprises a parameter related to applying frequency-domain spectral shaping and providing tone reservation, and an indication that the bandwidth extension ratio is larger or no smaller than the threshold.

6. The method of claim 5, wherein the plurality of indications of the signal parameters further comprises an indication of a ratio between frequency-domain spectral shaping and tone reservation for a total bandwidth.

7. A method, for carrying out at a network element, the method comprising:
receiving, from a device, a plurality of indications of signal parameters;
transmitting, to the device, a plurality of indications of signal generation parameters, the signal generation parameters selected based, at least in part, on the signal parameters, the signal generation parameters including at least one of a selected roll off factor and a selected guard factor;
receiving a signal; and
decoding, according to the signal generation parameters, the signal.

8. The method of claim 7, wherein the plurality of indications of the signal parameters comprises a threshold and further comprises an indication that the signal generation parameters are expected to include a parameter related to applying frequency-domain spectral shaping, and an indication that the bandwidth extension ratio is smaller or no larger than the threshold.

9. The method of claim 7, wherein the plurality of indications of the signal parameters comprises a threshold and further comprises an indication that the signal generation parameters include a parameter related to providing tone reservation, and an indication that the bandwidth extension ratio is smaller or no larger than the threshold.

10. The method of claim 7, wherein the plurality of indications of the signal parameters comprises a threshold and further comprises a parameter related to applying frequency-domain spectral shaping and providing tone reservation, and an indication that the bandwidth extension ratio is larger or no smaller than the threshold.

11. An apparatus comprising:
at least one processor; and
at least one memory storing instructions which, when executed by the at least one processor, cause the apparatus to:
transmit, to a network element, a plurality of indications of signal parameters, the signal parameters selected based on capabilities of the apparatus, the signal parameters including at least one of a minimum roll off factor and a minimum guard factor;
receive, from the network element, a plurality of indications of signal generation parameters; and
transmit a signal, the signal generated according to the signal generation parameters.

12. The apparatus of claim 11, wherein the plurality of indications of the signal parameters are associated with at least one of a range of modulation-coding scheme indices, a range of bandwidths, or a range of modulation orders.

13. The apparatus of claim 11, wherein the plurality of indications of the signal parameters comprises a threshold and further comprises an indication that the signal generation parameters are expected to include a parameter related to applying frequency-domain spectral shaping, and an indication that the bandwidth extension ratio is smaller or no larger than the threshold.

14. The apparatus of claim 11, wherein the plurality of indications of the signal parameters comprises a threshold and further comprises an indication that the signal generation parameters include a parameter related to providing tone reservation, and an indication that the bandwidth extension ratio is smaller or no larger than the threshold.

15. The apparatus of claim 11, wherein the plurality of indications of the signal parameters comprises a threshold and further comprises a parameter related to applying frequency-domain spectral shaping and providing tone reservation, and an indication that the bandwidth extension ratio is larger or no smaller than the threshold.

16. The apparatus of claim 15, wherein the plurality of indications of the signal parameters further comprises an indication of a ratio between frequency-domain spectral shaping and tone reservation for a total bandwidth.

17. An apparatus comprising:
at least one processor; and
at least one memory storing instructions which, when executed by the at least one processor, cause the apparatus to:
receive, from a device, a plurality of indications of signal parameters;
transmit, to the device, a plurality of indications of signal generation parameters, the signal generation parameters selected based, at least in part, on the signal parameters, the signal generation parameters including at least one of a selected roll off factor and a selected guard factor;
receive a signal; and
decode, according to the signal generation parameters, the signal.

18. The apparatus of claim 17, wherein the plurality of indications of the signal parameters comprises a threshold and further comprises an indication that the signal generation parameters are expected to include a parameter related to applying frequency-domain spectral shaping, and an indication that the bandwidth extension ratio is smaller or no larger than the threshold.

19. The apparatus of claim 17, wherein the plurality of indications of the signal parameters comprises a threshold and further comprises an indication that the signal generation parameters include a parameter related to providing tone reservation, and an indication that the bandwidth extension ratio is smaller or no larger than the threshold.

20. The apparatus of claim 17, wherein the plurality of indications of the signal parameters comprises a threshold and further comprises a parameter related to applying frequency-domain spectral shaping and providing tone reservation, and an indication that the bandwidth extension ratio is larger or no smaller than the threshold.
